(19) United States
(12) Patent Application Publication
(10) Pub. No.: US 2004/0132530 A1
(43) Pub. Date: Jul. 8, 2004

(54) Management system for entertainment machines

(76) Inventors: Tuomo Rutanen, Reston, VA (US); Drew Uplinger, Centreville, VA (US); Christopher Norman, Staffordshire (GB)

Correspondence Address: HOLLANDER LAW FIRM, P.L.C., SUITE 305, 10300 EATON PLACE, FAIRFAX, VA, 22030

(21) Appl. No.: 10/470,403

(22) PCT Filed: Jan. 21, 2002
(86) PCT No.: PCT/GB02/00269

(51) Int. Cl. A63F 9/24; A63F 13/00

(52) U.S. Cl. 463/42; 463/29

(57) ABSTRACT

A management system for credit-operated games machines (2) has a central control device (19) which communicates with the machines (2) at their respective sites via wireless data link. GSM mobile phone technology with SMS text messaging is used. Machine operation and performance data can be uploaded from the machines (2) to the central control device (19) and data and commands can be sent to and from the central control device (19) and the machines (2). The machines (2) may be video terminals programmed with multiple games which are authenticated and enabled via the wireless data link. The machines (2) may incorporate Wireless Interface Modules (18) and the central control device (19) may be linked via the internet to the wireless net work using gateway application software (21). A machine player can obtain game-playing credit by mobile phone (22) communication with the central control device (19) which debits his account and sends credit commands to the machine (2). Reports on machine performance and messages are distributed by the central control device (19) to the local machine managers by e-mail or Internet. The local machine managers can be authorised, by wireless communications, to gain access to the machines (2) for coin box emptying.

This invention relates to a management system for entertainment machines.

The invention is particularly, although not exclusively concerned with player-operable entertainment machines, especially coin-operated amusement with prizes (AWP) machines, such as ‘fruit’ or ‘poker’ machines of the kind having a main display device for displaying a selected combination of symbols at a win zone. As used herein the term coin is intended also to cover tokens, charge or credit cards or any other means of supplying credit or monetary value. This main display device may comprise actual or video-simulated side-by-side symbol-bearing reels which are rotatable about a common horizontal axis within a housing behind a window at the win zone.

It is known to link AWP machines to a remote central computer for management purposes. Data stored in the machines relating to machine operations can be uploaded to the central computer for monitoring and analysis. Also, alarm conditions, such as machine failures or break in or tampering attempts, can be notified to the central computer.

It is also known to download data, such as game software from the central computer to remotely linked machines.

With known arrangements the connection between the AWP machines and the remote computer may involve a hard wired link, and/or an installed dial-up modem and telephone line link. Such links are however often not convenient or possible at all machine locations and have limitations.

An object of the present invention is to provide an improved management system which is more widely applicable and with which the limitations of hard wiring and installed line links can be avoided or at least reduced.

According to the invention therefore there is provided a management system for use with a plurality of entertainment machines, the system comprising a central control device remote from the machines, a plurality of communication interface devices respectively local to and associated with the machines, and a data link which can be established between the machine interface devices and the central control device operable to transfer data from the machines to the control device and to transmit control signals between the control device and the machines, characterised in that the data link comprises a wireless link.

With this arrangement a management system for the machines can be established and implemented in a convenient and flexible manner. For example, management of machines can be effected such as to allow maximisation of income from gaming machines, without infra-structure costs associated with wired systems.

The wireless link may be of any suitable kind but preferably uses a mobile phone communications network, especially GSM (Global System for Mobile Communications). GSM is typically an open system digital technology using time division multiple access transmission methods. Wireless transmissions can be made with GSM technology by accessing the GSM network using a suitable GSM modem. The transmissions may involve small amounts of text message data (e.g. up to 160 bytes) which can be transmitted using SMS messaging (Short Message Service), and/or large amounts of data e.g. using HSCSD (High Speed Circuit-Switched Data Call). With HSCSD typically transmission rates up to 38.4 kbps can be achieved by allocation of up to eight time slots. Messaging and data transmission techniques other than GSM, SMS and HSCSD may be used alternatively or additionally such as packet data transmission technology.

Thus the interface devices of the machines and the control device may be connected to suitable wireless transmitting/receiving apparatus. Most conveniently each machine may have its own transmitting/receiving apparatus which may be mounted on or adjacent to or incorporated in the machine. Alternatively, if desired the transmitting/receiving apparatus may be separate from and connected to (via any suitable wireless or wired link) the machines and/or there may be a common transmitting/receiving apparatus for two or more machines. Particularly in the case of the central control device wireless transmission and/or reception may be via a network link or the like to a remote transmission and/or reception centre. Thus, the link may be an internet link and the central control device may run GSM gateway application software whereby data is transmitted via the internet between the central control device and a remote GSM centre where transmission/reception of GSM signals is handled.

The wireless apparatus of the central control device and/or the machines may be operable to communicate with other devices separate from the central control device and machines. Such other devices may for example comprise mobile phones or other palm, hand-held or laptop communication devices of field engineers, machine operators or owners, or players.

The central control device may also have provision for communication other than by wireless transmission/reception. Thus, the control device may incorporate or be connected to a data store which can be accessed passively or interactively.

Access to such data store may be by way of network connection, particularly an Internet or WAP or similar network connection. Thus, the data store may be provided on a web server which can be accessed e.g. by a pc using browser software.

Also, the control device may be operable to send messages or data by any other suitable communication technique which is capable of automated machine implementation, such as e-mail, fax, recorded voice transmissions and the like.

With regard to the nature of the data transmissions between the machines and the central control device these may comprise any one or more of the following categories:

i. authorisation signals or codes implementing or permitting implementation of changes at the machines;

ii. information concerning performance and operation of the machines;

iii. alerts relating to significant events e.g. opening of access doors of machines, break-downs, tampering, etc.

iv. transfer of files or software or information for game-play.

v. machine identification and/or history information.

vi. user status and authorisation information to create, delete and change identity and level of access to machine control functions by authorised persons.

Data transmissions between the machines and the central control device may occur periodically as batches, say every hour or every week, or it may occur more frequently e.g. at shorter intervals or on demand or as required, depending on the nature and reason for the data transmission.

Data transmissions between the machines and the central control device may comprise data pertinent to individual machines and/or data common to a group of machines.

Data transmissions between the central control device and the machines may initiate or otherwise correspond or relate to transmissions between the central control device and/or machines and the other devices as mentioned above. Thus, for example, a significant event alert, as mentioned above under heading iii. may prompt the transmission from the central control device e.g. by SMS text or e-mail, of a call out message to a field engineer.

Data transmissions between the central control device and the machines may authorise or otherwise control machine operation in correspondence with communications between the central control device and/or machines with other devices local to the machines. Thus, for example, provision may be made for a player of a machine to use a mobile phone or other device to select or modify a game played on a machine or to add monetary credits for game play or obtain money or change from a machine. Also, provision may be made for an authorised person local to a machine to collect data and/or cash directly from a machine, or otherwise control or interact with the machine.

In one embodiment a player or authorised person can send a message with a mobile phone, such as an SMS text message, which is routed to the central control device and which after authentication and interpretation can be used to generate a command to be transmitted to the machine.

Referring in more detail to the above headings i.-vi.:

i. Provision can be made at a machine, or group of machines, for parameters of game play or machine operation to be changed or selected.

In one embodiment, software for multiple different games can be stored on a machine (or group of machines) e.g. by loading from CD-ROM or other storage medium, and the games (or one or more selected ones of the games) may be made available for play (i.e. ‘enabled’) only after authorisation by data transmission from the central control device. This enabling may be effected by an identifying notification signal relating to the games being sent to the central control device. The central control device may then check to determine that the games are appropriate i.e. known games approved for use on the particular machine or machines (e.g. as determined by the machine and/or location identity) whereupon the presence of the games in the machine or machines may be stored in a database of the central control device and an authorisation or enabling command or code may then be transmitted to the machine or machines.

In a further embodiment, a machine user, i.e. an owner or operator or other local authorised person, can be authorised to change or select play parameters, such as volume, price of play, target percentage, individual coin and note acceptance and the like, and/or other parameters, such as data transmission parameters, e.g. frequency of periodic data reporting. Data concerning requests for changes identified e.g. by a user code may be transmitted from machines to the central control device and if authenticated and appropriate an authorisation or enabling command or code may then be transmitted to the machine or machines.

ii. Information concerning performance and operation of machines may relate to any suitable machine parameters for example including any one or more of the following:

a) Inactive Machines;

b) Machine Audit;

c) GSM SIM card and machine transmitting/receiving apparatus inventory;

d) Unacknowledged Commands;

e) Game Performance;

f) Machine Performance;

g) Game Revenue;

h) Machine Revenue;

i) Game Usage;

j) Machine Usage.

Reports can be assembled by the central control device and then despatched, or made available to a user. Reporting to the user may be on a scheduled regular basis, or on demand, e.g. by e-mail. Alternatively, the report may be posted on a web site or otherwise may be made accessible to the authorised user.

Monitoring of machine operation and performance enables controls and configurational changes to be applied efficiently on an automatic or demand basis. By way of example, in the case where multiple games are available, control parameters can be determined between different games. That is, control information can be passed from one game to another game on the same machine whereby fluctuations in machine revenue and service call outs to re-fill the machine can be minimised.

iii. alerts relating to significant events may be logged. These events may be of any suitable nature indicating that a machine is possibly being subjected to a break-in or tampering or failure, such as opening of a machine access door, power-failure, anomalous machine results e.g. indicating unexpected or undesirable win statistics, etc. Logged information may be stored at the central control device and may then be reported in like manner to ii. Above. For some or all of the notified alerts, reports may be sent immediately to appropriate persons such as field engineers or the machine user, e.g. by SMS text or e-mail.

iv. File transfer may be used by upload from the machines to the central control device in order to provide detailed information e.g. game test results monitored over a period. Also file transfer may be used to download from the central control device to the machines partial game data or software (e.g. an update ‘patch’) or even the entire data and/or software for a game to supplement or replace an existing resident game.

v. Machine identification may be stored at the central control device providing information specific to a particular machine such as the identity of that machine, the identity of its current site, historical information e.g. relating to creation data and ownership of machine components (such as PC, monitors, modems, SIM cards, etc). This facilitates asset tracking whereby capital assets can be tracked once out in the field. Also this provides identification information to relate to machine operational information.

In addition, machine identification may be associated with machine location to enable stolen machines to be identified and located e.g. using GSM triangulation technology which may be responsive to transmissions from the machine occurring routinely and/or stimulated by demand from the central control device.

vi. User identification may be stored at the central control device and this may be related to access level. Thus, there may be provision at the central control device for creating and deleting users and for specifying which components of the system they have access to. For example, a user can be created who only has access to certain reports and who cannot communicate with machines on site directly.

With regard to the central control device and the machines, these may take any suitable form.

Preferably, the central control device comprises a computer running appropriate software which may handle data transmissions automatically and/or may have provision for manual control e.g. by keyboard.

The computer may comprise a central server and may run a software application such as JAVA, ORACLE, BEA Weblogic.

The machines may take any suitable form and may incorporate any suitable software. Conveniently the machines may comprise video terminals which can readily provide a multigame function. Provision may be made for local user access to machine control systems by manual controls of the machine such as buttons, a keyboard, a touch screen or the like, preferably in association with a screen display. Alternatively or additionally access may be via a local wired or wireless link to the machine e.g. from an infra-red linked hand held device or other wireless device. The software may be written in C or C⁺⁺ and also HTML and/or Perl Script.

The machines may be coin-operated entertainment machines, particularly AWP machines as described above.

The invention will now be described further by way of example only and with reference to the accompanying drawings in which:

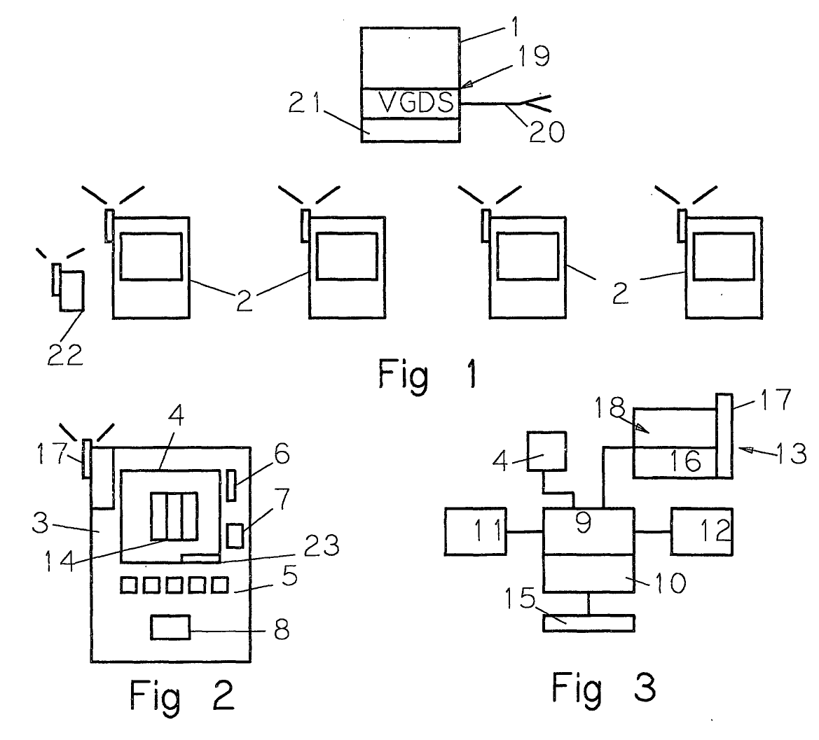

FIG. 1 is a schematic representation of one form of an entertainment machine management system according to the invention;

FIG. 2 is an enlarged schematic view of one entertainment machine of the system; and

FIG. 3 is a block circuit diagram of the machine.

FIG. 1 shows a management system comprising a server 1 located at a suitable central control location, and multiple entertainment machines 2 located at sites which may be remote from the server 1 and from each other, although there may be a group of machines 2 at a single site.

Each machine 2 is a video coin-operated AWP fruit machine as described hereinbefore. The machine comprises a cabinet 3 which incorporates a VDU display device 4, external player controls 5 such as press-buttons or touch screen controls, a coin slot 6 and/or note handler 7, and a pay-out slot 8. Within the cabinet 3 there is a control device 9 which includes a microprocessor control device and a data store 10 and to which is connected a coin/note mechanism 11, the VDU display device 4, a pay-out mechanism 12, and communications equipment 13 described hereinafter.

The control device 9 includes game and application software and the store 10 includes software and data for multiple games which can be played on the machine.

The games, or at least some of them are of the ‘fruit machine’ kind whereby simulated rotatable reels 14 are produced on the VDU display device 4 in conventional manner.

Provision is made for adding games to the store 10 by means of a CD-ROM which can be inserted into a CD-ROM reader 15 in the machine.

The cabinet 3 has a lockable door by means of which access can be to the interior of the cabinet for insertion of CD-ROMs into the reader 15 and also for removing cash from a cash box, topping up coins in the pay out mechanism 12, and for general services and maintenance purposes.

The communications equipment 13 includes a GSM module 16 with an antenna 17 and a SIM card. This can send and also receive GSM wireless transmissions. The GSM module 16 is connected to or incorporated within a Wireless Interface Module 18 (WIM) having a Remote Monitoring Device which effects interface between control or application software of the machine with the GSM module 16 so that the machine software can initiate and control data transmission and reception via the WIM 18.

The remote server 1 forms part of a central computerised control device 19 which runs Video Game Delivery System (VGDS) application software.

The central control device 19 is connected to the Internet (at 20) and has application software 21 which establishes a gateway to the Wireless Telecommunication Network which is capable of sending and receiving messages under the control of the device 19. That is, data can be transferred between the central control device 19 and a remote GSM communication point via an Internet connection managed by the application software 21.

Machines 2 of the system so far described can be used by players as follows:

A player has to establish credit to a value equal to that required to play one or more games. The player can then play a game in conventional manner by operating player controls 5 to cause the video-simulated reels 14 to rotate and then come to rest to select a combination of symbols. Supplementary game features such as nudge, hold, gamble, feature games, etc. can be used. In the event that the outcome is of a winning nature an award is made available to the player.

The credit may be established in conventional manner by supplying money, e.g. as coins or notes, to the machine, and awards may be paid out by dispense of coins through the pay-out opening 8.

Alternatively, credit may be established remotely. To achieve this, in accordance with instructions provided on or adjacent to the machine, the player makes a telephone call requesting the supply of credit to the machine against an authorised debit to the player's account.

This can be done using SMS text via the player's mobile phone 22. The player sends a short message consisting of:

a machine identification number (shown on the machine);

the number or value of machine credits required (related to the price per game);

the player's personal account identification.

This data string is sent to the telephone number given on the machine.

The data string is thereby transmitted to the central control device 19 or to a reception point from where it is routed to the control device 19.

At the central control device 19, the data is extracted and utilised by the application software (VGDS). The player's personal account information is matched against a database of authorised accounts. Before the player can use remote game credit it is necessary for the player to establish an authorised credit account. The player is then issued with an account identification which is entered into the database at the central control device 19.

After successful matching of the account identification with the database, the VGDS software computes the credit requirement based on the known price per game for the identified machine (which is also contained in a database of the central control device 19) and the value or number of game plays requested by the player.

The central control device then transmits a message via its wireless network gateway to the WIM 18 of the particular machine using SMS text messaging, under the control of the control device application software VGDS, which constitutes a command interpreted by the machine software as game credit to the requested value. This credit is shown in conventional manner on a meter display 23 on the machine 2.

The corresponding monetary value is debited to the player's account by the central control device and recompense is obtained in accordance with a pre-arranged billing arrangement. This may involve billing the player or by directly debiting a bank or credit card account or a credit balance pre-established by the player, or otherwise.

With this remote credit arrangement, any award attained by the player may be paid out as a conventional cash pay out, and/or by credit to the player's account via SMS text message transmitted back from the machine WIM 18 to the central control device WIM 21.

The player can also use the remote telephone credit facility to obtain cash in the case where the machine incorporates or is accompanied by a cash dispenser. The player sends a SMS text message which is received by the central control device 19 which results in a debit to the account of the player and the transmission of a command to the machine 2 to cause it to dispense a requested and approved sum of money through the machine payout opening 8 or a separate opening of the cash dispenser.

Other functions of a dispense or other nature can be effected and administered in similar manner. In this respect, the game machine 2 constitutes a video computer terminal and can be adapted as a stand-alone terminal or connected externally (e.g. to the Internet) or to associated equipment to provide a means for selling facilities, services or products administered by the described system.

Also, if desired, the system may be utilised to administer other functions not necessarily related to or involving the machine 2 or any associated equipment. By way of example, the remote credit facility described above may be used to top up mobile phone call credits or to purchase ring tones or otherwise, whereby an SMS text message is sent to the central control device 19 from the mobile phone 22 and the mobile phone user purchases facilities or services by debit to his account.

The software and hardware of the central control device 19 and the machines 2 support SMS protocols and use of network or application layer techniques to ensure message delivery. Both SMS-MO (mobile organisation) and SMS-MT (mobile termination) are supported, as well as SMS concatenation.

As an alternative to remote credit facility by SMS text messaging it is possible to use other techniques such as WAP, Internet or even voice call whereby the player uses these techniques to route a message to the central control device 19 which results in facilities, services or products being supplied to the player and/or commands being sent to the machine 2 in any suitable manner.

As an alternative to the provision of a separate WIM 18 or GSM module 16 in each machine 2 it is possible to use Bluetooth or other integrated wireless or other networking or linking technology between grouped local machines whereby messages are routed for all such local machines through a common WIM 18 or GSM module 16.

Reference is made specifically to SMS and GSM but of course other wireless communication techniques may be substituted.

Also, as an alternative to locally inserted cash (coins or notes) or remote debiting, other forms of payment can be used, such as credit card, cash card, electronic money sources or the like which can be interfaced with the system in any suitable manner e.g. via a reader in the machine 2 or elsewhere.

As described above, after establishing adequate credit, the player can play a ‘fruit machine’ game on the machine 2.

The machine may incorporate a single available game with which the machine is pre-programmed. Alternatively, the machine may incorporate a plurality of games from which a game to be played can be pre-selected. This pre-selection may be offered to the player i.e. such that the player has a menu of games from which he can select a desired game; or it may be available only to an authorised user or other person such that such person sets up the machine with a single game or a range of games to be made available to the player.

The games from which the selection can be made are resident in the machine and may be stored on the CD-ROM in the reader 15 or any other suitable permanent or replaceable medium.

The game storage medium may be preinstalled during manufacture of the machine and/or it may be installed or replaced on site e.g. by insertion of a CD-ROM into the reader 15 which may be accessed through the usual access door of the machine.

After installation of the CD-ROM, use of the games has to be logged and authenticated before they can be played, and this is done using the above described wireless management system.

Thus, after installation of the CD-ROM an SMS text message is transmitted from the machine 2 to the central control device 19. this contains identification of the machine and the games on the CD-ROM. Assuming that the CD-ROM is authenticated as valid and permissible for use on the particular machine 2, the central control device 19 adds the games to its database in relation to that machine. This may be in addition to other games previously installed on the machine and still usable. At the same time, the machine user (e.g. the site owner or manager) can be billed for the games by debit to his account. A command is then sent from the central control device 19 to the machine 2 to enable use of the games on the machine.

This arrangement is flexible and can accommodate different possibilities. By way of example, availability of games can be varied on any desired schedule e.g. such that certain games are only available for a predetermined period or at predetermined times of the day or on predetermined days or only after a predetermined date or otherwise. Also, billing to the site owner/manager may be computed on any suitable basis such as frequency of play of individual games, etc.

Authenticated, enabled games can subsequently be removed on a permanent or temporary basis.

Also, the described system can be used to modify or configure the machine 2 in relation to the games e.g. such that maximum payouts, payout percentages, price per play, relative frequency of different game features, etc. can all be changed. This may be done by the local user sending requests to the central control device 19. These requests may be from the machine 2 using the machine's WIM 18 by entering requests e.g. through concealed controls, security coded VDU screen features, hand held communication devices linked to the machine, etc., or by separate communication e.g. SMS text messaging from a mobile phone or through a secure WAP or Internet site or otherwise. Changes are implemented or enabled by commands transmitted back to the machine 2. Different local users may have different authorisation levels giving different possibilities for changing machine configuration. Alternatively or additionally changes may be initiated or controlled by the central control device 19.

The different games available may all be of the ‘fruit machine’ kind. Alternatively one or more may be of a different AWP or SWP (skill with prizes) or other kind. Also, the machine may be set up, enabled and configured for features other than the playing of games. Thus, the machine 2 may have supplementary or separate modes such as ‘attract’ modes where game features are presented to attract players, test modes where games can be run for test purposes, and advertising modes in which advertisements can be shown on the VDU screen 4 between or during game play. By way of example, advertising material can be loaded and enabled from CD-ROM in like manner to game loading and enabling as mentioned above.

In addition to the playing of independent single-player games, provision may be made for multi-player linked games on the same and/or different machines 2, particularly on a competitive basis. The management system and wireless technology described above can be used to implement and administer such arrangements e.g. by transmitting game results from individual games and machines to the central control device 19 and then relaying data or commands from the central control device 19 to the machines 2 in order to notify players as to results on other machines and to make awards available at selected machines 2 derived from competitive activity over multiple machines.

The wireless communication link between individual machines 2 and the central control device 19 is also utilisable for alert messages, local machine access functions, and data transmissions.

Alert messages can be sent to notify significant events immediately or on a periodic basis (i.e. they may be stored and sent subsequently) depending on the importance and urgency of the messages.

The significant events may relate to possible break in or tampering, e.g. in the case where the machine access door is opened or spurious external transmissions are detected etc, or to failures, such as mains power failure, jammed payout mechanism, etc, or matters of a more routine nature such as elapse of servicing periods, cash box emptying requirement, cash dispense reservoir falling low, etc.

The alert message may be sent, conveniently as an SMS text message, to the central control device 19 where it is recorded, logged against parameters such as machine identification, date, etc., and a report and/or call for assistance can then be sent out from the central control device 19 and/or directly from the machine WIM 18.

The call for assistance may be an SMS text message sent to the mobile phone of a field engineer or local machine user.

Alternatively or additionally a message may be sent by e-mail or fax or voice call or by posting on a WAP or Internet Web site.

Such alerts may be initiated automatically within the machine by appropriate sensors and associated circuitry. They may also be initiated by the local machine user who can do this either by using controls on or associated with the machine or by using SMS text messaging from a mobile phone or otherwise.

The wireless system may be used to authorise and control local machine access by the local user or other authorised person.

Thus, access to the interior of the machine e.g. for cash box emptying, servicing or maintenance, operation of adjustment controls, etc. may be effected by transmission of a request and code from the local user to the central control device 19 which, if authenticated and authorised, results in commands being transmitted back to the machine effecting or enabling the required access.

The transmitted request may be by SMS text or otherwise via the machine WIM 18 or direct e.g. from the user's mobile phone to the central control device 19.

In a particularly advantageous manner this enables emptying of the coin box in a secure and accurately monitored manner by the local user thereby avoiding or reducing the need for attendance by other personnel.

Data can be transmitted between the central control device 19 and the machines 2 using circuit switched or packet data technology.

Data from the central control device 19 to the machines may be used to send entire game software, or patches to resident software, e.g. in substitution for (or to accompany) the above described CD-ROM game storage.

Data from the machines 2 to the central control device 19 may be used for reporting machine operational and performance data.

Data is collected within the machine from the usual meters and other storage relating to, for example:

Machine, site and equipment identity;

Machine usage (duration and numbers of games played);

Game performance (outcome of games, occurrence of features, etc);

Financial performance (percentage pay out, overall takings, etc);

Event occurrence (machine failures, tampering, etc.);

Status (coin content, servicing requirements, etc.);

System usage (log of wireless transmissions, user requests, configuration changes, etc).

All such data is stored within the machine 2 and is periodically transmitted, via the WIM 18, to the central control device, as one or more files. This may occur say every hour and/or every week or at any other desired interval initiated by the machine 2 or on demand from the central control device 19.

The data is stored and processed at the central control device 19 and is used to generate reports. The reports are made available to the machine user and/or to any other authorised person on any suitable basis e.g. on demand or periodically.

Depending on the nature and size of the reports these may be made available in any suitable manner such as by direct transmission e.g. by e-mail, fax, SMS text messaging or by posting at an accessible site such as an Internet or WAP Web site.

Different reports may be available depending on the level of authorisation of different users or other authorised persons. Provision may be made for changing levels of authorisation, adding or deleting authorised persons.

Distribution of reports may be effected on an automatic and/or operator controlled basis.

The reports may, for example, include the following:

a) lnactive Machines—enabling tracking which machines on site have not reported data for a specified period;

b) Machine Audit—Allows tracking of operational costs by providing a summary of message traffic to and from machines;

c) SIM and Remote Monitoring Device Inventory—Allows asset tracking of modems and SIM cards;

d) Unacknowledged Commands—Allows tracking of the reliability of the communications and hence performance of an SMS carrier;

e) Game Performance—Provides a game performance indicator by averaging the revenue taken per game across all machines;

f) Machine Performance—Provides a machine performance indicator by showing the revenue taken by a particular machine and the combination of games available for play.

g) Game Revenue—Summarises the total revenue on a per game basis;

h) Machine Revenue—Summarises the total revenue on a per machine basis;

i) Game Usage—Provides an indicator on how available and popular a particular game is by summarising how many machines the game is available on and how many games have been played.

j) Machine Usage—Provides an indicator of the popularity of individual machines by summarising how many games have been played and their availability.

With the embodiment described above an effective and versatile machine management system can be installed and operated in a particularly convenient and cost effective manner. Infrastructure associated with wired systems can be eliminated or at least minimised.

It is of course to be understood that the invention is not intended to be restricted to the details of the above embodiment which are described by way of example only.

1. A management system for use with a plurality of entertainment machines, the system comprising a central control device remote from the machines, a plurality of communication interface devices respectively local to and associated with the machines, and a data link which can be established between the machine interface devices and the central control device operable to transfer data from the machines to the control device and to transmit control signals between the control device and the machines, characterised in that the data link comprises a wireless link.

2. A system according to claim 1 characterised in that each machine incorporates a respective transmitting/receiving apparatus.

3. A system according to claim 1 or 2 characterised in that the central control device is operable to communicate with other devices separate from the central control device and the machines.

4. A system according to claim 3 characterised in that the communication with the other devices is by way of wireless link.

5. A system according to any one of claims 1-4 characterised in that the (or each) wireless link uses a mobile phone communications network.

6. A system according to claim 5 characterised in that the wireless link is a GSM link.

7. A system according to claim 5 or 6 characterised in that the wireless link uses SMS messaging.

8. A system according to any one of claims 5-7 characterised in that the wireless link uses circuit switched or packet data transmissions.

9. A system according to any one of claims 1-8 characterised in that the wireless link with the central control device is via a remote wireless transmitting/receiving point connected to the central control device via an internet link.

10. A system according to claim 3 or any claim dependent thereon characterised in that the communications with the other devices is via an accessible data store.

11. A system according to claim 10 characterised in that the data store is accessible by Internet or WAP connection.

12. A system according to claim 3 or any claim dependent thereon characterised in that the communication with other devices is via e-mail.

13. A system according to any one of claims 1 to 12 characterised in that the data link between the central control device and the machines is used for any one or more of:
i) authorisation signals for implementation of changes at the machines;
ii) machine performance and operation information;
iii) machine significant event alerts;
iv) game software files;
v) machine identification data;
vi) machine user status-information.

14. A system according to claim 3 or any claim dependent thereon characterised in that the central control device is operable to communicate with mobile phones local to the machines.

15. A system according to claim 14 characterised in that the central control device is operable to receive a message from such mobile phone and in response thereto transmit a command to one or more machines.

16. A system according to claim 15 characterised in that at least one said command establishes game play credits for the player.

17. A system according to claim 16 characterised in that the value of such credits is debited by the central control device from an account for the player.

18. A system according to any one of claims 15 to 17 wherein the machines have multiple games installed characterised in that at least one said command enables play of selected said games.

19. A system according to claim 18 characterised in that the central control device is adapted to debit a game-enabling value to accounts of machine users.

20. A system according to any one of claims 15-19 wherein games on the machines have changeable configurations or parameters characterised in that at least one said command enables changes thereof.

21. A system according to claim 3 or any claim dependent thereon characterised in that the said communication with other devices comprises provision of reports relating to machine performance and operation.

22. A system according to any one of claims 1 to 21 wherein the machines have multiple games installed characterised in that control information is passed between such games for use in changing game parameters.

23. A system according to any one of claims 1 to 22 characterised in that the central control device has a database of data relating to identification of individual machines.

24. A system according to any one of claims 1 to 23 characterised in that the central control device has a database of data relating to identification of users of the machine.

25. A system according to any one of claims 1 to 24 characterised in that the central control device is operable to locate individual machines using wireless triangulation.

26. A system according to any one of claims 1 to 25 characterised in that the machines comprise video terminals.

27. A system according to any one of claims 1 to 26 characterised in that the machines are coin-operated player-operable entertainment machines.

28. A system according to claim 27 characterised in that the machines are AWP entertainment machines having a main display device comprising rotatable symbol-bearing reels.
